(19) United States
(12) Patent Application Publication
(10) Pub. No.: US 2009/0272185 A1
(43) Pub. Date: Nov. 5, 2009

(54) MATERIAL ADHESION PERFORMANCE TESTER

(76) Inventors: Tung Yuan Tsaur, Gaithersburg, MD (US); Chao-Dan Lai, Yangmei Township (TW)

Correspondence Address: OCCHIUTI ROHLICEK & TSAO, LLP, 10 FAWCETT STREET, CAMBRIDGE, MA, 02138, US

(21) Appl. No.: 12/113,549

(22) Filed: May 1, 2008

(51) Int. Cl. G01N 19/04

(52) U.S. Cl. 73/150 A

(57) ABSTRACT

A system for testing the adhesion performance of materials under various temperatures, comprises a hot/cold plate mounted on top of the sled of an adhesion/release tester, a thermoelectric (TE) controller, and a temperature-controllable fluid circulator. The hot/cold plate in the system allows convenient and rapid change of the test temperature.

### FIELD OF THE INVENTION

The present invention relates to a system for testing the adhesion performance of materials under various temperatures.

### BACKGROUND OF THE INVENTION

The conventional pressure sensitive adhesion tests, such as tack, peel, and shear (or holding power) tests, are all performed at room temperature—a constant temperature at 23±2° C., and relative humidity of 50±5% RH. However, in the reality, the actual service temperatures for most pressure-sensitive adhesives (PSAs) may vary from −20 to +80° C. Many PSAs may perform similarly at room temperature, but differ a lot in their adhesion performance and/or fracture modes at low and/or high temperatures. Unfortunately, so far, there is no standard test method globally that can easily and precisely determine the pressure sensitive adhesion performance at varied temperatures besides room temperature.

Two conventional techniques are commonly used for evaluating pressure sensitive adhesion performance at varied temperatures in the PSA industry as follows:
1) A common way used at many research institutions is by using an oven or chamber attached on a peeling machine (e.g. an Instron). However, the entire effective peeling length within the compact oven is very limited. In addition, it is not easy and quick enough to reach a stable and constant temperature for test specimens with either a heating or a cooling medium.
2) The second way is by using an adhesion tester placed inside a temperature controllable box or room and triggering the test from outside of the box or room. To avoid signal interference when testing adhesives inside a temperature controllable box or room, all electronic devices of the testing machine must be placed outside the oven or room. Only mechanical portion of the machine can be placed inside the conditioned environment. Therefore, a specially designed testing machine is required for each individual lab. Moreover, in an air conditioning room, it is extremely time consuming and costly to reach a consistent and stable target temperature to be tested.

In view of the above, a more convenient and effective method and system for testing adhesion performance of materials under various temperatures is desired.

### BRIEF SUMMARY OF THE INVENTION

Accordingly, the present invention provides a system for conveniently testing the adhesion performance of materials under various temperatures, comprising:
(i) an adhesion/release tester with a hot/cold plate mounted on top of its moving sled, wherein the hot/cold plate consists of a metal top plate in contact with a metal bottom plate, and at least one thermoelectric (TE) module held between the top and bottom plates, said bottom plate having a fluid circulating channel within it;
(ii) a TE controller operatively connected to the TE module in the hot/cold plate, wherein the TE controller has feedback temperature controlling function; and
(iii) a temperature-controllable fluid circulator operatively connected to the fluid circulating channel within the bottom plate of the hot/cold plate.

According to the present invention, any required test temperature on the upper surface of the hot/cold plates can be reached and stabilized in less than 5 minutes.

The present invention also provides a method for testing the adhesion performance of a material, comprising attaching a specimen of the test material on the upper surface of the hot/cold plate, which is mounted on top of the moving sled of an adhesion/release tester, and performing the adhesion test with said tester.

Other features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description and by practice of the invention.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 illustrates an embodiment of an adhesion performance testing system (without an adhesion/release tester) according to the present invention.

FIGS. 2A and 2B illustrate an embodiment of a combination of a hot/cold plate and the temperature controller according to the present invention.

FIG. 3 is a photograph showing a hot/cold plate of the present invention containing three TE modules lining on the upper surface of the bottom plate (top plate removed to facilitate photographing).

FIG. 4 is a photograph showing a hot/cold plate of the present invention mounted on top of the sled of Adhesion/Release Tester AR-1500 (Chemlnstruments, Fairfield, Ohio). A TE controller is also shown to the left of the adhesion/release tester.

### DETAILED DESCRIPTION OF THE INVENTION

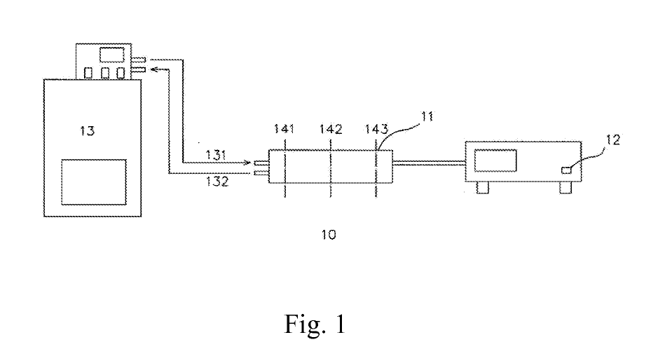

Referring now to the drawings. An adhesion performance testing system of the present invention is schematically shown in FIG. 1. The system is designated by the reference number 10.

As shown in FIG. 1, a hot/cold plate 11 is simultaneously connected to a thermoelectric (TE) controller 12 and a temperature-controllable fluid circulator 13. The temperature-controllable fluid circulator 13 is connected by two flexible tubes 131 and 132 to the fluid circulating channel in the hot/cold plate 11. The hot/cold plate 11 is mounted on top of the moving sled of an adhesion/release tester (not shown in FIG. 1) and fixed with screws at through holes 141, 142 and 143.

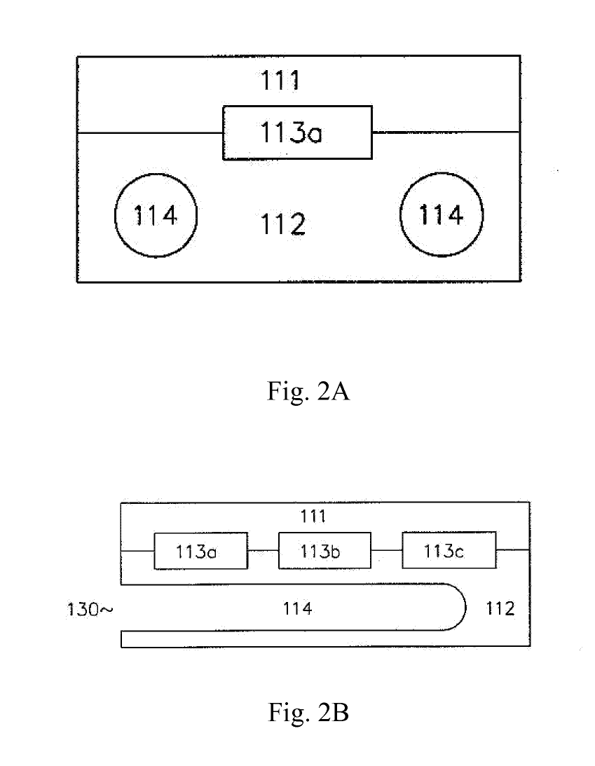

FIG. 2 shows two cross sectional views of the hot/cold plate 11 from different directions. As shown in FIG. 2A, the hot/cold plate 11 is composed of a metal top plate 111 and a metal bottom plate 112, holding between them a TE module 113a. The bottom plate 112 is generally thicker than the top plate 111 in order to accommodate a fluid circulating channel 114. FIG. 2B shows a cross sectional view of the same hot/cold plate 11 from a direction perpendicular to that of FIG. 2A. In FIG. 2B we can see the other two TE modules 113b and 113c, as well as the opening 130 of the fluid circulating channel 114.

According to the present invention, the top and bottom plates of the hot/cold plate are made of metal, preferably metal with excellent heat conductivity. In an embodiment of the present invention, the top and bottom plates of the hot/cold plate are made of aluminum.

TE modules, also known as Peltier devices, are small solid-state devices that function as heat pumps. A “typical” unit is a few millimeters thick by a few millimeters to a few centimeters square. It is a sandwich formed by two ceramic plates with an array of small bismuth telluride (Bi₂Te₃) cubes (“couples”) in between. When a DC current is applied heat is moved from one side of the device to the other, where it must be removed with a heatsink. The “cold” side may be used to cool an electronic device such as a microprocessor or a photodetector. If the current is reversed, the device also makes an excellent heater.

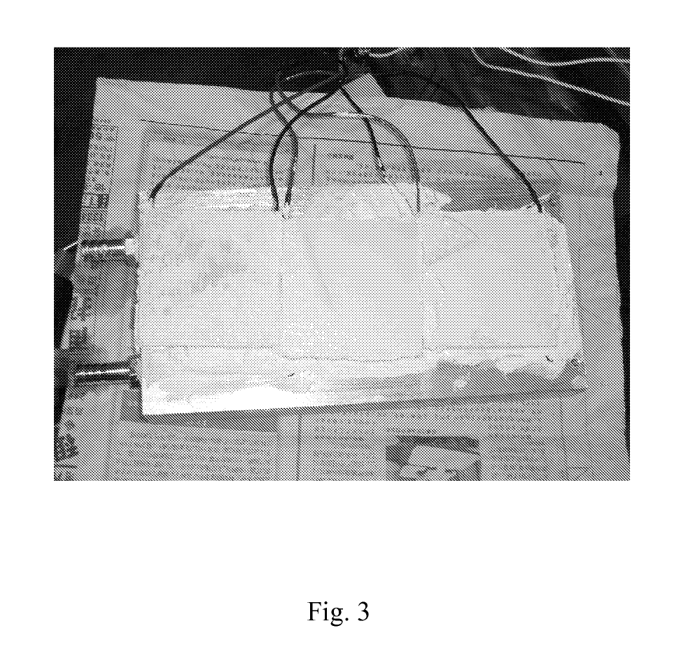

According to the present invention, the number of TE modules used in the hot/cold plate is determined by the dimensions of the hot/cold plate, the required temperature range, and the required warming/cooling speed. In an embodiment of the present invention, the hot/cold plate contains three TE modules. FIG. 3 shows an example of the hot/cold plate of the present invention containing three TE modules lining on the upper surface of the bottom plate (top plate removed to facilitate photographing).

TE modules are commercially available. Manufactures include, but not limited to, Marlow (Dallas, Tex.), Melcor (Cleveland, Ohio), and Tellurex (Traverse City, Mich.).

The TE controller used in the present invention is also commercially available. Preferably, the TE controller has feedback temperature controlling function, so that a stable test temperature can be achieved on the surface of the hot/cold plate. For a list of manufacturers of TE controllers, go to www.peltier-info.com/accessories.html.

The temperature-controllable fluid circulator used in the present invention is also commercially available. Generally, common lab water circulators are suitable for use in the present invention. Basically, the serving temperature of the hot/cold plate ranges from 40° C. below to 80° C. above the temperature of the circulating fluid. Therefore, a 10° C. fluid can generate any test temperature between −30° C. and 90° C. However, due to the heat loss during fluid circulation, using water as the circulating fluid can typically generate test temperatures between −20° C. and 80° C. This wide service temperature range of about 100° C. has covered most realistic temperatures for PSA applications on earth. If a lower or higher test temperature outside this typical working range is required, it can be achieved by adding coolant to or heating up the circulating fluid.

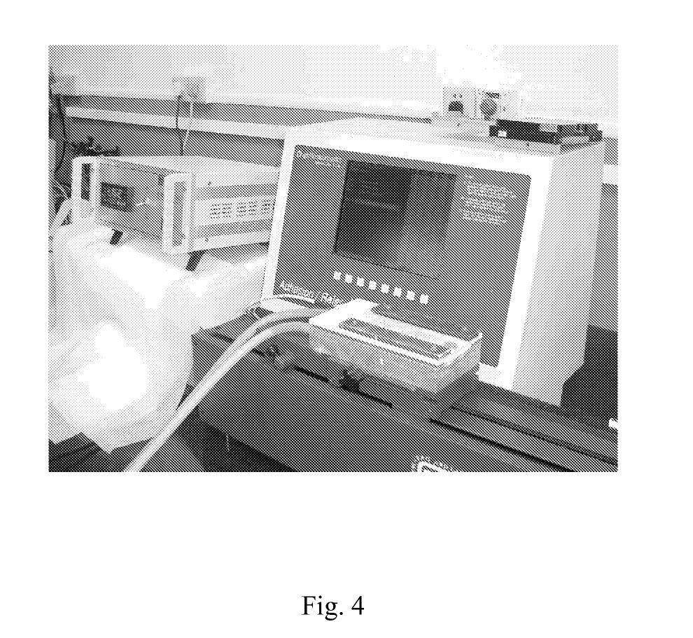

The adhesion/release tester used in the present invention is one that is commonly used in the laboratory for testing the adhesion performance of PSA. In an embodiment of the present invention, the adhesion/release tester is Adhesion/Release Tester AR-1000 or AR-1500 by ChemInstruments (Fairfield, Ohio). FIG. 4 shows an example of the hot/cold plate of the present invention fixed on the sled of Adhesion/Release Tester AR-1500.

The present invention is further illustrated with the following examples. These examples are offered for the purpose of illustration and are not to be construed in any way as limiting the scope of the present invention.

### EXAMPLE

### 180° -Peel Force Test of HMPSA

1. Specimen Preparation

Three commercially available hot-melt pressure-sensitive adhesives (HMPSAs), designated as Adhesives A, B and C, were used in the present example. The adhesives were individually coated with a hot melt coater onto a 50-μm polyester (PET) film to form a 25-μm adhesive film.

2. Test System Setup

The hot/cold plate used in the present example had its top and bottom plates made in aluminum and comprised three TE modules (max. current=12 A; max. voltage=15 V; max. power=300 W). The hot/cold plate was pre-mounted on top of the sled of Adhesion/Release Tester AR-1500 (ChemInstruments, Fairfield, Ohio). The dimensions of the hot/cold plates (200 mm*100 mm*40 mm) corresponded to those of the sled. A typical temperature-controllable water circulator was connected to the fluid circulating channel within the hot/cold plate by two flexible tubes (inlet and outlet). The TE modules in the hot/cold plate were connected to a TE controller equipped with a temperature sensor probe, which was inserted between the top and bottom plates of the hot/cold plate.

3. Test Preparation

The water circulator and TE controller were individually connected to a power outlet and turned on. The temperature of water in the circulator was selected based on the following principle: the serving temperature of the hot/cold plate ranges from 40° C. below to 80° C. above the temperature of the circulating fluid. In the present example, the water temperature was set at 10° C. When the temperature of water in the circulator reached the set temperature, the TE controller was set to the first test temperature. When changing to another test temperature, the TE controller was set to the next test temperature and the heating/cooling switch on the controller was switched to the required side.

4. Testing Procedure

A test specimen prepared as described above was first rolled onto a standard stainless steel panel with a rubber roller. Then, the stainless steel panel was inserted into a slot on the surface of the hot/cold plate, with the test specimen facing upward. When the temperature of the test specimen reached the test temperature (this usually took a few minutes, and could be confirmed with a non-contact IR thermometer), the 180°-peel force test was performed according to Test Method A of PSTC-101 (PSTC Test Method, 14^{th} Edition) at the peeling rate of 12 in/min. The peeling adhesion force and fracture mode under various test temperatures were recorded.

5. Results

The 180°-peel forces and fracture modes of Adhesives A, B, and C at various temperatures were listed in the following table.

| | Peel Force (Kg/in) | | | | | | | | | |
|---|---|---|---|---|---|---|---|---|---|---|
| | 50° C. | 40° C. | 30° C. | 25° C. | 20° C. | 15° C. | 10° C. | 5° C. | 0° C. | −5° C. |
| A | 1.1 | 2.0 | 2.9 | 3.2 | 4.0 | 4.3 | 4.9 | 5.1 | 5.5 | 0-7.2 |
| | CF | CF | CF | CF | CF | CF | CF | CF | CF | SS |
| B | 1.8 | 2.5 | 3.7 | 3.8 | 4.5 | 4.9 | 5.3 | 0-6.4 | | |
| | CF | CF | CF | CF | CF | CF | CF | SS | | |
| C | 2.1 | 2.7 | 3.9 | 4.2 | 4.7 | 0-5.5 | | | | |
| | CF | CF | CF | CF | CF | SS | | | | |

Note:
CF = cohesion fail mode;
SS = stick-slip mode;
lab adhesion tests normally stop at the temperature where SS mode appears.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A system for testing the adhesion performance of materials under various temperatures, comprising:
(i) an adhesion/release tester with a hot/cold plate mounted on top of its moving sled, wherein the hot/cold plate consists of a metal top plate in contact with a metal bottom plate, and at least one thermoelectric (TE) module held between the top and bottom plates, said bottom plate having a fluid circulating channel within it;
(ii) a TE controller operatively connected to the TE module in the hot/cold plate, wherein the TE controller has feedback temperature controlling function; and
(iii) a temperature-controllable fluid circulator operatively connected to the fluid circulating channel within the bottom plate of the hot/cold plate.

2. The system according to claim 1, wherein the top and bottom plates of the hot/cold plate are made of aluminum.

3. The system according to claim 1, wherein the dimensions of the hot/cold plate are 200 mm×100 mm×40 mm.

4. The system according to claim 1, wherein the hot/cold plate comprises three TE modules.

5. The system according to claim 6, wherein the TE modules have max. current of 12 A, max. voltage of 15 V, and max. power of 300 W.

6. The system according to claim 1, wherein the circulating fluid is water.

7. The system according to claim 1, wherein the serving temperature range of the hot/cold plate is −20° C. to 80° C.
